(19) United States
(12) Patent Application Publication
(10) Pub. No.: US 2015/0302654 A1
(43) Pub. Date: Oct. 22, 2015

(54) THERMAL IMAGING ACCESSORY FOR HEAD-MOUNTED SMART DEVICE

(71) Applicant: Ivan Arbouzov, Irving, TX (US)

(72) Inventor: Ivan Arbouzov, Irving, TX (US)

(21) Appl. No.: 14/693,348

(22) Filed: Apr. 22, 2015

Related U.S. Application Data
(60) Provisional application No. 61/982,641, filed on Apr. 22, 2014.

(51) Int. Cl. G06T 19/00; G02B 27/01; H04N 5/33; G01J 5/02; G01J 5/04

(52) U.S. Cl. CPC G06T 19/006; G01J 5/025; G01J 5/041; H04N 5/33; G02B 27/017; G06T 2207/10048

(57) ABSTRACT

A thermal imaging accessory (TIA) is linked with a head-mounted smart device (HMSD) with a data display for displaying data for an eye of a user wearing the HMSD. The HMSD supports the TIA in an orientation where a field-of-view of a thermal imaging camera of the TIA is substantially in alignment with the field-of-view of an eye looking through the data display. The HMSD is configured to: link the TIA to the HMSD, activate a thermal imaging application on the HMSD to receive data from the TIA and display it on an HMSD data display, receive thermal imaging data of a target from the TIA, process the thermal imaging data received from the TIA, and initiate a display of the processed thermal imaging data on the HMSD data display.

### BACKGROUND

Conventional thermal imaging devices, such as hand-held and stationary mounted systems, are typically created to provide reading data from the device related to an object(s) in the field-of-view of the device or to read data from an external stationary monitor. Typically, reading data is limited to use of an internal display of the device to output the visual image generated by the device. Conventional thermal imaging devices are also not typically designed to allow simultaneous normal and enhanced visual observation of the same object; such as a first eye viewing an object with a second eye viewing data associated with the object on a display lens/screen situated between the object and the second eye.

Another traditional feature of a typical thermal imaging device is a viewfinder that consists of a monocular eye-piece and a display positioned in a field-of-view of the thermal imaging optical system or a binocular type system. It is impossible with these conventional thermal imaging devices to overlay a naked eye observation with a thermal image, and/or to run complex programs that will, for example, assist the user with processing received visual information.

### SUMMARY

The present disclosure describes a thermal imaging accessory (TIA) for a head-mounted smart device (HMSD).

The TIA is linked with the HMSD with a data display for displaying data for an eye of a user wearing the HMSD. The HMSD supports the TIA in an orientation where a field-of-view of a thermal imaging camera of the TIA is substantially in alignment with the field-of-view of an eye looking through the data display. The HMSD is configured to: link the TIA to the HMSD, activate a thermal imaging application on the HMSD to receive data from the TIA and display it on an HMSD data display, receive thermal imaging data of a target from the TIA, process the thermal imaging data received from the TIA, and initiate a display of the processed thermal imaging data on the HMSD data display.

Other implementations of this aspect can include corresponding computer systems, apparatuses, and computer programs recorded on one or more computer-readable media/storage devices, each configured to perform actions of methods associated with the described thermal imaging accessory. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

For example, one computer-implemented method includes linking the TIA to the HMSD; activating a thermal imaging application on the HMSD to receive data from the TIA and display it on an HMSD data display; receiving thermal imaging data of a target from the TIA; processing the thermal imaging data received from the TIA; and initiating a display of the processed thermal imaging data on the HMSD data display.

The foregoing and other implementations can each optionally include one or more of the following features, alone or in combination:

A first aspect, combinable with the general implementation, comprising linking a mobile computing device (MCD) to the at least one of the TIA or the HMSD.

A second aspect, combinable with any of the previous aspects, comprising executing an application on the HMSD that seeks out at least one of an in-range TIA or MCD to establish a data connection with the HMSD.

A third aspect, combinable with any of the previous aspects, comprising transmitting data from the HMSD to the TIA.

A fourth aspect, combinable with any of the previous aspects, wherein additional data is processed with the thermal imaging data.

A fifth aspect, combinable with any of the previous aspects, comprising determining a range from the HMSD to the target.

A sixth aspect, combinable with any of the previous aspects, wherein the processed thermal imaging data is displayed according to preset or dynamically-determined preferences.

The subject matter described in this specification can be implemented in particular implementations so as to realize one or more of the following advantages. First, thermal, range finding, audio, camera, and/or other data can be received from external components (e.g., the thermal imaging accessory) and fed into a head-mounted smart device such as GOOGLE GLASS or similar processing unit. This provides the ability to see/hear data and images from the external components using the display/processing capabilities of the head-mounted smart device. Second, a naked first eye observation is overlaid with a thermal image viewed by a second eye permitting both an unaltered and augmented/enhanced view of an object simultaneously. Third, thermal image data can be combined with other available data (e.g., from a laser range finder, Global Positioning System (GPS) positioning data, compass, etc. on either the thermal imaging accessory and/or a mobile computing device) made available by the thermal imaging accessory and processed. For example, a program(s) can be run that can indicate a location/measurement of a viewed object (e.g., thermal signature, range, elevation, etc.)—perhaps in conjunction with a displayed map, ballistic, construction, logistical or any other useful data). Fourth, the head mounted smart device (and in some implementations the thermal imaging accessory and/or external mobile computing device) can be used to record audio, video, still images externally retrieved by the head-mounted smart device and/or thermal accessory, as well as the overlaid and/or calculated/processed data. Fifth, thermal imaging data, visual data, and/or other described data can be transmitted (e.g., by phone, network, BLUETOOTH, WIFI, and/or other transmission means consistent with this disclosure) to other thermal image accessory users, mobile computing devices, and/or to a centralized processing center (e.g., a police/military command center) for a particular task. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates a front perspective view of a thermal imaging accessory for a head-mounted smart device according to an implementation.

FIG. 2 illustrates a top perspective view of a thermal imaging accessory for a head-mounted smart device attached to the head-mounted smart device according to an implementation.

FIG. 3 illustrates a perspective view of a thermal imaging accessory for a head-mounted smart device attached to the head-mounted smart device according to an implementation.

FIG. 4 is a block diagram illustrating components of an example thermal imaging accessory for a head-mounted smart device system according to an implementation.

FIG. 5 is a flow chart illustrating a method for use of a thermal imaging accessory for a head-mounted smart device according to an implementation.

FIG. 6 illustrates a perspective view of an alternative thermal imaging accessory attached to a head-mounted support according to an implementation.

FIG. 7 illustrates a different perspective view of the alternative thermal imaging accessory of FIG. 6 attached to the head-mounted support according to an implementation.

FIG. 8 illustrates another perspective view of the alternative thermal imaging accessory of FIG. 6 attached to the head-mounted support according to an implementation.

Like reference numbers and designations in the various drawings indicate like elements.

### DETAILED DESCRIPTION

The following description is presented to enable any person skilled in the art to make and use the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

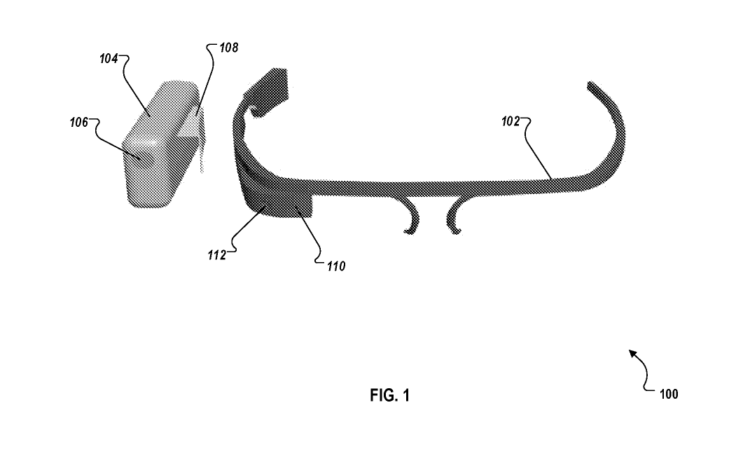

FIG. 1 illustrates a front perspective view 100 of a thermal imaging accessory (TIA) 104 for a head-mounted smart device 102 according to an implementation. Head-mounted smart device 102 can be any wearable smart device worn on the head (e.g., GOOGLE GLASS, a headband-mounted device, virtual reality-type glasses/gear, etc.) as long as the head-mounted smart device 102 permits the user to view data through at least one eye (e.g., on the data display 110). In some implementations, the head-mounted smart device (HMSD) 102 can display data to both eyes simultaneously. In some implementations, the data display 110 is transparent to a user and permits the user to view an object through the data display 110 as well as data overlaid over the object, i.e., an augmented reality type of display, whether the data is associated with the viewed object or not. For example, the data display 110 can be a transparent piece of plastic, glass, ceramic, etc. that allows the user to look though the data display. A small optical device—such as a projective device (not illustrated)—projects an image onto the data display (e.g., interior, exterior, or a combination of both) that can be viewed by an eye. In this implementation, the HMSD 102 would normally contain a power supply, compass, angle, direction and motion sensor, a Wi-Fi module to receive and transmit an image to the data display, and/or other instruments, tools, functionality, etc.

The HMSD 102, TIA 104, data display 110, and/or other described components can be ruggedized to be waterproof, shockproof, temperature proof, chemical proof, etc. In some implementations, the described components can be configured with a secure data communication system (e.g., encrypted) and be personalized for use only by a specific user (e.g., through the use of biometrics such as retinal scan, voice patterns, or other biometrics, etc.).

The head-mounted smart device 102 is used as an attachment point for the TIA 104. In the illustrated implementation, the TIA 104 can be attached to the HMSD 102 using the attachment clip 108. The attachment clip can take many forms apart from that illustrated, for example a screw, tie, bracket, clamp, etc. In some implementations, the HMSD 102 is specifically designed/modified to provide an attachment point for the TIA 104, for example with a cutout, bracket, socket, etc. configured into a temple piece. In some implementations, the attachment clip 108 (and/or various components that can make up the attachment clip 108) can be configured of one or more of plastic or of any other sufficiently rigid and strong material such as metal, ceramic, etc.

In the illustrated implementation, the thermal imaging accessory is mounted to the side of the HMSD 102 (e.g., on a temple/ear piece). In other implementations, the TIA 104 can be mounted in other locations (e.g., on the front at the bridge of the nose, on a separate band on the head, on a hat/helmet, etc.) as long as the thermal imaging lens 106 is in alignment or substantially in alignment with the field-of-view of optical camera 112 of the HMSD 102.

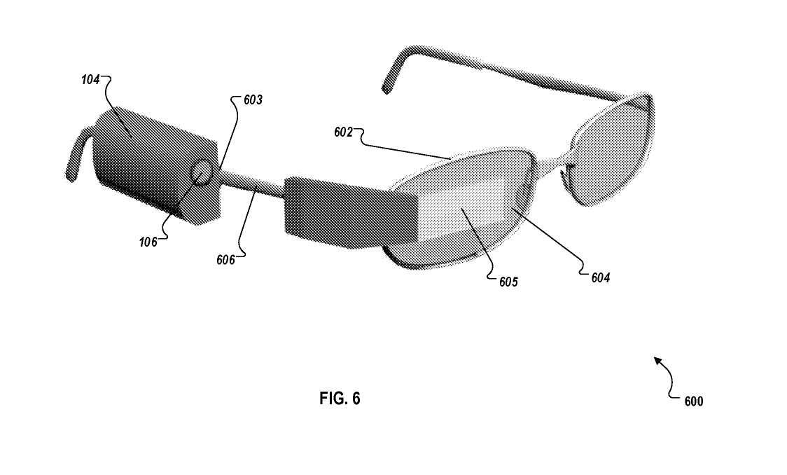

In some specialized implementations (including in the alternative implementation below described in FIGS. 6-8), the TIA 104 (or additional cameras, etc. associated with the TIA 104 or additional differently oriented TIAs 104) can be oriented to receive data from behind to the side, top, and/or bottom of the user (e.g., rear-view for a competitive cyclist, different views from a skydiver, etc.)

Thermal imaging lens 106 is configured to transmit and/or influence/modify a particular type of electromagnetic radiation before receipt by a digital camera (not illustrated) associated with the TIA 104. For example, thermal imaging lens 106 can be configured to be transparent to infrared (IR) radiation such as in thermal imaging systems. In some implementations, thermal imaging lens 106 can be configured of Germanium (Ge), quartz, AMTIER, barium fluoride, calcium fluoride, sodium chloride, CLEARTRAN, fused silica, silicon, polyethylene, IR transparent ceramics, and/or any other type of substance transparent to infrared electromagnetic radiation. In some implementations, the thermal imaging lens 106 can be made of a substance transparent to both optical and IR radiation wavelengths, e.g., quartz, polyethylene, etc. In some implementations, the lens can be removable to permit different wavelengths of electromagnetic radiation to be influenced/modified. In some implementations, the entire digital camera assembly associated with the thermal imaging lens 106 can be removed and replaced within the TIA 104 to change functionality. Although the TIA 104 is illustrated with only the thermal imaging lens 106 (providing thermal imaging functionality), in other implementations, the thermal imaging accessory can have more than one thermal imaging lens 106 and/or other incorporated instruments, such as internal clock, compass, GPS receiver/transmitter, laser range finder, microphone (including directional microphone), optical camera (of various possible resolutions—low and high), gyroscope, accelerometer, inclinometer, motion sensor, altitude sensor, thermometer, atmospheric pressure sensor, etc. in order to provide additional information about visual or other data gathered by the TIA 104.

In some implementations, the optical camera and/or other instruments of the TIA 104 can be in alignment or substantially in alignment with the field of view of the optical camera 112 of the HMSD 102. Although only illustrated with an optical camera 112, in some implementations, the HMSD 102 can have some or all of the possible instruments listed for the TIA 104. In some implementations, the instruments can work together to enhance data gathering capability. In other implementations, one or more instruments can be housed in devices separately from the thermal imaging device 104 and, for example, be proximate to and/or worn by the wearer of the HMSD 102 (e.g., a belt-mounted KESTREL-type device, etc.) for various operational, tactical, ergonomic, usability reasons, etc.

In some implementations, the TIA 104 can interface/communicate with the HMSD 102 using a wired and/or wireless connection (not illustrated). For example, the temple piece of the HMSD 102 proximate to the TIA 104 can be configured with a data port (e.g., USB, FIREWIRE, etc.). The HMSD 102 and the TIA 104 can also be configured with a wireless radio to permit wireless communication of data between both. In some implementations, data can be transmitted both by wire and wirelessly simultaneously.

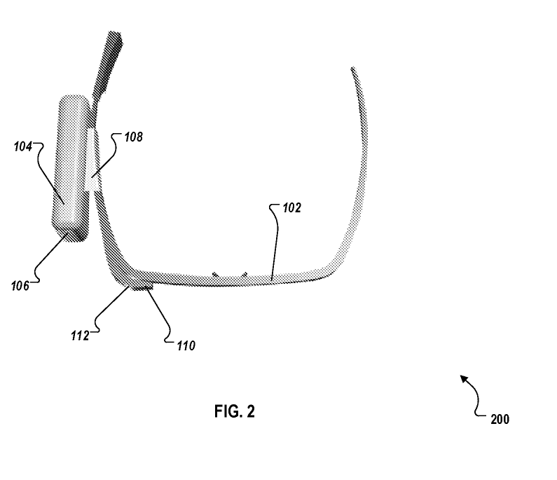

FIG. 2 illustrates a top perspective view 200 of a thermal imaging accessory for a head-mounted smart device attached to the head-mounted smart device according to an implementation.

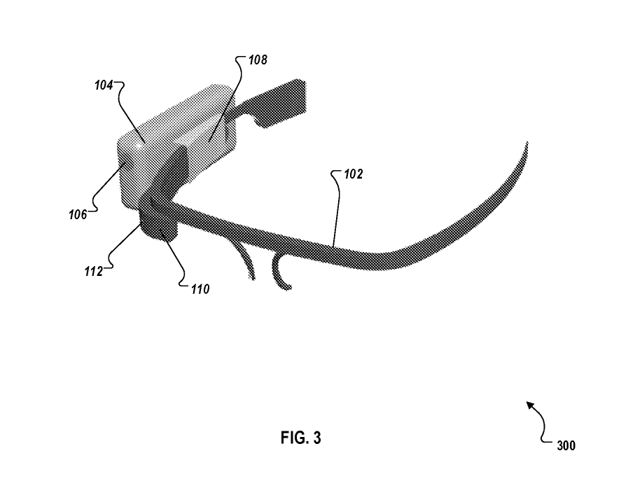

FIG. 3 illustrates a perspective view 300 of a thermal imaging accessory for a head-mounted smart device attached to the head-mounted smart device according to an implementation.

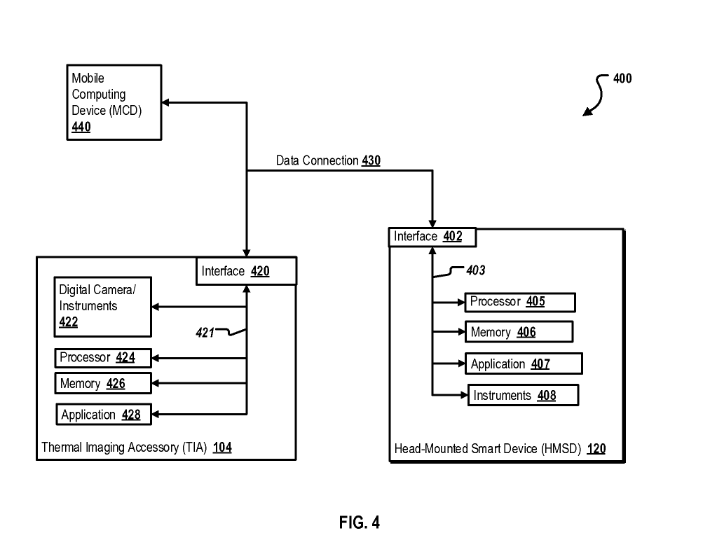

FIG. 4 is a block diagram 400 illustrating components of an example thermal imaging accessory for a head-mounted smart device system according to an implementation. The illustrated system includes or is communicably coupled with a HMSD 102, TIA 104, and mobile computing device (MCD) 440 that communicate across a data connection 430. In some implementations, one or more components of the LRFA system 400 may be configured to operate in conjunction with other mobile computing devices and/or LRFAs.

At a high level, the HMSD 102 is an electronic computing device operable to receive, transmit process, store, manage, and/or display data and information associated with the system 400. The HMSD 102 is typically a head-mounted wearable computing device, but can encompass any other appropriate computer processing device. As will be apparent to those of ordinary skill in the art, HMSD 102 can also contain necessary un-illustrated control/processing circuitry, and/or other components to permit the above-described functionality/operation.

The HMSD 102 is responsible for generating requests and/or receiving, among other things, data from the TIA 104, MCD 440, and/or other instances of the HMSD 102 and responding to, displaying, and/or processing to the received data. In some implementations, the HMSD 102 processes the data using an application 407. In addition to requests sent to and/or received from the TIA 104 and/or MCD 440, requests may also be sent to and/or received from other TIAs 104 and/or MCDs. For example, one HMSD 102 can be designated as a “controller” and receive data from multiple TIAs 104, MCDs 440, and/or HMSDs 102 to more accurately determine range calculations to a targeted object, verify data, and permit visual data from multiple perspectives to be viewed by a user.

Each of the components of the HMSD 102 can communicate using a system bus 403. In some implementations, any and/or all the components of the HMSD 102, both hardware and/or software, may interface with each other and/or the interface 402 over the system bus 403 using an application programming interface (API), service layer, or the like (not illustrated). The API may include specifications for routines, data structures, and object classes. The API may be either computer-language independent or dependent and refer to a complete interface, a single function, or even a set of APIs. The service layer provides software services to the system 400. The functionality of the HMSD 102 may be accessible for all service consumers using this service layer. Software services, such as those provided by the service layer, provide reusable, defined business functionalities through a defined interface. For example, the interface may be software written in JAVA, C++, or other suitable language providing data in extensible markup language (XML) format or other suitable format. Any or all parts of the API and/or the service layer may be implemented as child or sub-modules of another software module without departing from the scope of this disclosure. For example, the API 112 could be integrated into the application 407.

The HMSD 102 includes an interface 402. Although illustrated as a single interface 402 in FIG. 4, two or more interfaces 402 may be used according to particular needs, desires, or particular implementations of the system 400. The interface 402 is used by the HMSD 102 for communicating with a TIA 104 and/or MCD 440 connected to the data connection 430. Generally, the interface 402 comprises logic encoded in software and/or hardware in a suitable combination and operable to communicate with the data connection 430. More specifically, the interface 402 may comprise software supporting one or more communication protocols associated with communications such that the data connection 430 or data connection 430 hardware is operable to communicate physical signals within and outside of the illustrated system 400. The data connection can include a wireless network (e.g., cellular, WIFI, BLUETOOTH, etc.) and/or direct physical connection (e.g., cable, etc.)

The HMSD 102 includes a processor 405. Although illustrated as a single processor 405 in FIG. 1, two or more processors may be used according to particular needs, desires, or particular implementations of the system 400. The processor 405 executes instructions and manipulates data to perform the operations/functions of the HMSD 102. For example, the processor 405 can execute functionality to provide a data display on the data display 110.

The HMSD 102 also includes a memory 406 that holds data for the HMSD 102, TIA 104, and/or MCD 440. Although illustrated as a single memory 406 in FIG. 4, two or more memories may be used according to particular needs, desires, or particular implementations of the system 400. While memory 406 is illustrated as an integral component of the HMSD 102, in alternative implementations, memory 406 can be external to the HMSD 102 and/or the system 400. In some implementations, memory 406 can be configured to store, for example, one or more instances of user profiles, communication data, target object data, recorded audio/video data, applications, and/or other appropriate data.

The application 407 is a software calculation engine providing, among other things, functionality related to operations of the HMSD 102 and/or functionality associated with the TIA 104 and/or the MCD 440. For example, application 407 can be a downloadable application installed on the HMSD 102. The application 407 can also allow for configuration of the HMSD 102, generating and initiating display of GUI layouts on an associated display, receiving and processing data (e.g., from the TIA 104 and/or MCD 440), performing complex calculations, etc.

Although illustrated as a single application 407, the application 407 may be implemented as multiple applications 407. In addition, although illustrated as integral to the HMSD 102, in alternative implementations, the application 407 can be external to the HMSD 102 and/or the system 400 (e.g., wholly or partially executing on a different implementation of another HMSD 102 (not illustrated), etc.).

Instruments 408 can include various hardware and/or software instruments to collect data to make available to the application 407. For example, in some implementations, instruments 408 can include a data display, digital camera, a global positioning system (GPS) receiver/transmitter, an accelerometer, a gyroscopic sensor, compass, wireless radio, temperature/pressure sensor, altimeter, and/or other instrument (including those described above with respect to FIG. 1) suitable for the purposes of the system 400.

In some implementations, the interface 420, digital camera/instruments 422, processor 422, memory 426, and application 428 of the TIA 104 can be either similar or different than those described above (particularly with respect to the HMSD 102), but performing tasks, storing data, etc. particularly suited to the purposes of the TIA 104. The TIA 104 can communicate with the HMSD 102, the MCD 440, and/or other instances of the TIA 104 over data connection 430 as appropriate to send and/or receive data. In some implementations, each of the components of the TIA 104 can communicate using a system bus 421. In some instances, the functionality provided by the system bus 421 can be similar to the above-described system bus 403 with respect to components of the HMSD 120 that are similar to, or can perform the same operations as, components of the TIA 104 and also depending upon the overall needs of the system 400 consistent with this disclosure as understood by those of ordinary skill in the art.

In some implementations, the MCD 440 can be configured with an interface, digital camera/instruments, processor, memory, application, and/or other elements of the TIA 104 either similar or different than those described above (particularly with respect to the HMSD 102 and/or the TIA 104), but performing tasks, storing data, etc. particularly suited to the purposes of the MCD 440. The MCD 440 can communicate with the HMSD 102, TIA 104, and/or other instances of the MCD 440 over data connection 430 as appropriate to send and/or receive data.

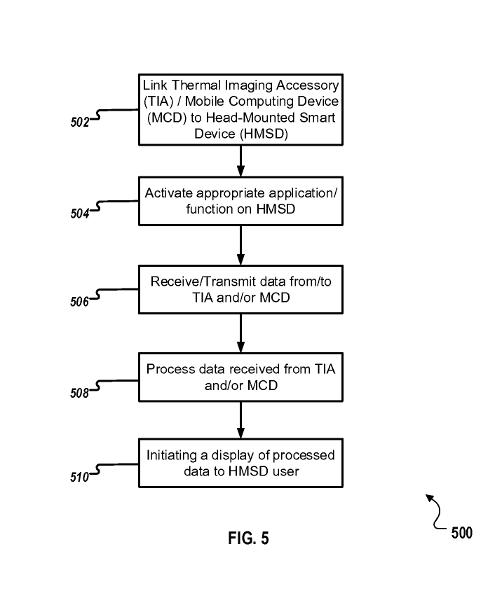

FIG. 5 is a flow chart illustrating a method 500 for use of a thermal imaging accessory for a head-mounted smart device according to an implementation. For clarity of presentation, the description that follows generally describes method 500 in the context of FIGS. 1-4 and 6-8. However, it will be understood that method 500 may be performed, for example, by any other suitable system, environment, software, and hardware, or a combination of systems, environments, software, and hardware as appropriate. In some implementations, various steps of method 500 can be run in parallel, in combination, in loops, or in any order.

At 502, a head-mounted smart device (HMSD) is linked with a thermal imaging accessory (TIA) and (optionally) a mobile computing device (MCD). For example, the HMSD could execute an application that will seek out an in-range TIA and/or MCD possibly executing an application permitting a data connection with the HMSD. From 502, method 500 proceeds to 504.

At 504, an appropriate application/function is activated on the HMSD. For example, the user can activate a thermal imaging application on the HMSD to receive data from the TIA and display it on the HMSD data display. From 504, method 500 proceeds to 506.

At 506, data (e.g., thermal imaging and/or other data) is received/transmitted from/to the TIA and/or MCD. For example, the HMSD can request compass/GPS data from the MCD which is transmitted back to the HMSD as well as the HMSD transmitting a request to the TIA to zoom the digital camera associated with the thermal imaging lens to get a closer thermal image of a particular object being viewed by a user. From 506, method 500 proceeds to 508.

At 508, the HMSD processes data (e.g., thermal imaging and/or other data) received from the TIA and/or MCD associated with one or more targets. For example, received zoomed thermal image data is processed along with GPS and compass coordinates from the request to the MCD at 506. Additionally, the received data can be used to determine range from the user to an object if the TIA/MCD/HMCD is equipped with a laser rangefinder and ranging data to the viewed object is available. From 508, method 500 proceeds to 510.

At 510, the HMSD initiates a display of the processed data of 508 on the data display. Data can be displayed according to preset and/or dynamically determined preferences. After 510, method 500 stops.

FIG. 6 illustrates a perspective view 600 of an alternative thermal imaging accessory attached to a head-mounted support according to an implementation. Head-mounted support (HMS) 602 can be any wearable device worn on the head (e.g., eye glasses, etc.) as long as the HMS 602 permits the user to view data through at least one eye (e.g., on the alternative data display (ADD) 605 situated adjacent to the outside surface of a lens 604 (as illustrated)). Note that the ADD 605 is combination of a display portion (e.g., a flat rectangular piece of glass/plastic for displaying data) and a projection/display portion housing a projection/display apparatus to cause data to be displayed on the display portion (hereinafter, both collectively referred to as “ADD 605”). In some implementations, the HMS 602 can be used to display data to both eyes simultaneously (e.g., using two TIAs 104 and ADDs 605). In some implementations, the ADD 605 is transparent to a user and permits the user to view an object through the ADD 605 as well as data overlaid over the object, i.e., an augmented reality type of display, whether the data is associated with the viewed object or not. In some implementations, the lens 604 can be a prescription lens to correct a vision problem (e.g., nearsightedness, astigmatism, etc.). In other implementations, the lens can be non-prescription or not present with the ADD 605. In other implementations, the ADD 605 can be configured to use the lens 604 as opposed to a separate display portion as described above. For example, the ADD 605 projection/display portion could be configured to cause data to be displayed on the lens 604 (e.g., the interior or exterior surface).

The HMS 602 is used as an attachment point for the TIA 104. In the illustrated implementation, the TIA 104 can be attached to the HMS 602 using an attachment mechanism 603 of some type (e.g., the attachment clip 108, a screw, tie, bracket, clamp, etc.) In some implementations, the HMS 602 is specifically designed/modified to provide an attachment point for the TIA 104, for example with a cutout, bracket, socket, etc. configured into a temple piece. In some implementations, the attachment mechanism 603 (and/or various components that can make up the attachment mechanism 603), can be configured of one or more of plastic or of any other sufficiently rigid and strong material such as metal, ceramic, etc. Although the illustrated attachment mechanism 603 includes two attachment points to a temple/ear piece 606 of HMS 602, in other implementations the attachment mechanism can connect to the temple/ear piece 606 with a single or more than two attachment points.

In the illustrated implementation, the TIA 104 is mounted to the side of the HMS 602 (e.g., on a temple/ear piece 606 of HMS 602). In other implementations, the TIA 104 can be mounted in other locations (e.g., on the front at the bridge of the nose, on a separate band on the head, on a hat/helmet, etc.) as long as the thermal imaging lens 106 is in alignment or substantially in alignment with the field-of-view of the ADD 605 mounted to the HMS 602.

In this implementation, the ADD 605 is not dependent upon a “smart” device (e.g., the HMSD 102) for data to display on the ADD 605. In some implementations, the data display is configured to receive data directly from the TIA 104 and/or the MCD 440 using a wireless and/or wired connection. Typically, the ADD 605 would be configured to receive data from the MCD 440.

In this implementation, the ADD 605 can be a “clip-on” device (e.g., to a lens/frame of eyeglasses) or a specially configured display device to attach to the HMS 602. The TIA 104 and/or data display is configured to receive a data signal from the MCD 440. The ADD 605 can contain: a display as described above, any type of optics for transmitting the displayed image onto the data display 100 for viewing by a user's eye, a power supply, compass, angle, direction and motion sensor, and/or a Wi-Fi module to receive the image, and/or other instruments, tools, functionality, etc.

In some implementations, the housing of the alternative ADD 605 can be configured with different mounting mechanisms, including but not limited to: attachment to a glass/shield/visor with a suction cup, glue or other means (e.g.,: a diver's mask, a firefighter's helmet, a police riot shield, a military pilot's helmet visor, etc.) with clamps to a frame, magnets, or any other attachment mechanism consistent with this disclosure.

In some implementations, several data displays can be networked to permit multiple users to received and view the same image/data or the same image/data with various other types of added/overlaid data particular to a specific user. Similarly, in some implementations, data taken from multiple TIAs 104 can be processed/combined to create a “global” type data display (e.g., a firefighting/police/military type command post directing firefighters/police/military on a mission, etc.).

TIA 104 and/or thermal imaging lens 106 configurations, use, communication, etc. is similar to that as described above with respect to FIGS. 1-5 except that data is not transmitted to and/or received from a HMSD 102. In the various implementations of FIGS. 6-8, data is transmitted to and/or received between/by the TIA 104, ADD 605, and/or MCD 440. In other words, the HMS 602 is a “dumb” device, for support and/or display purposes only for data from the TIA 104, ADD 605, and/or MCD 440. This can be visualized by altering FIG. 4 by removing the HMSD 102 and data connection 430 to it from the figure leaving the MCD 440 and the TIA 104.

In some implementations, the TIA 104 can interface/communicate with the ADD 605 and/or MCD 440 using a wired and/or wireless connection (not illustrated). For example, the temple piece of the HMS 602 proximate to the TIA 104 can be configured with a data port (e.g., USB, FIREWIRE, etc.) and/or a wireless radio. In some implementations, data can be transmitted both by wire and wirelessly simultaneously.

In some implementations, a data signal is transmitted from the TIA 104 directly to the MCD 440 for processing. For example, the transmitted data signal can contain raw data from the TIA 104 thermal imaging sensor (and/or other sensors, instruments, etc.) that are processed by the MCD 440s's hardware and/or software into an image for display on the MCD 440 and/or by the ADD 605. In some implementations, the processed data can be transmitted by the MCD 440 to the TIA 104 to be transmitted to the ADD 605 for display to a user and/or transmitted by the MCD 440 to the ADD 605 directly. In some implementations, some data can be further processed by the TIA 104 before display on the ADD 605 while other data can be transmitted directly to the data display by the TIA 104 and/or the MCD 440.

In some implementations, the ADD 605 can be configured to project data particular to the location of a specific user, but other users will see the data processed and displayed with respect to their respective locations. For example, a police officer chasing a suspect can “mark” the suspect's location with a laser range finder integrated into the TIA 104 and send an image to a command post. Other police officers will see the direction of this location on their data displays in relation to their individual locations (e.g., so they can run to that location/move to intercept the suspect at another location).

In some implementations, the TIA 104 can be removable from the HMS 602 and transferrable to other systems, objects, etc. For example, the TIA 104 could be transferred from the HMS 602 to a firearm optical scope mount, a robotic delivery system (such as a bomb sniffing robot, or search and rescue robot), using the TIA on a pole or other object to peek over/around a wall, doorframe, etc. to protect the head/body of the user from harm (e.g., from gunfire, thrown objects, etc.). This would allow the user to still view data from the TIA 104 on the ADD 605 when the TIA 104 is disassociated from the HMS 602.

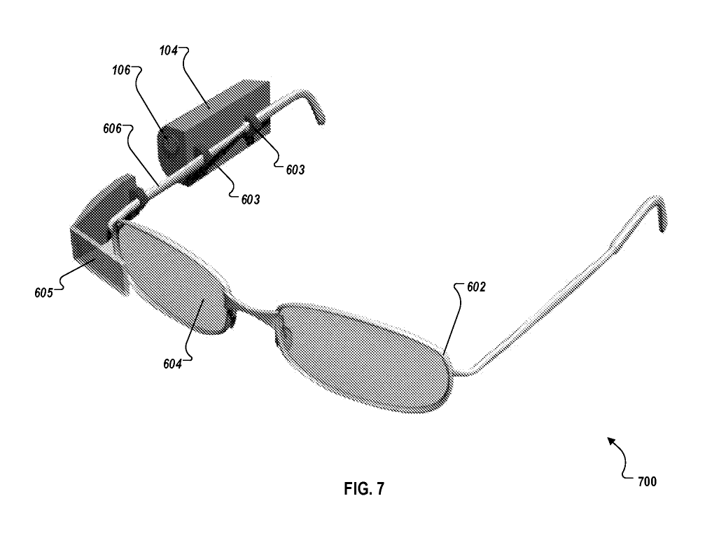

FIG. 7 illustrates a different perspective view 700 of the alternative thermal imaging accessory of FIG. 6 attached to the head-mounted support according to an implementation.

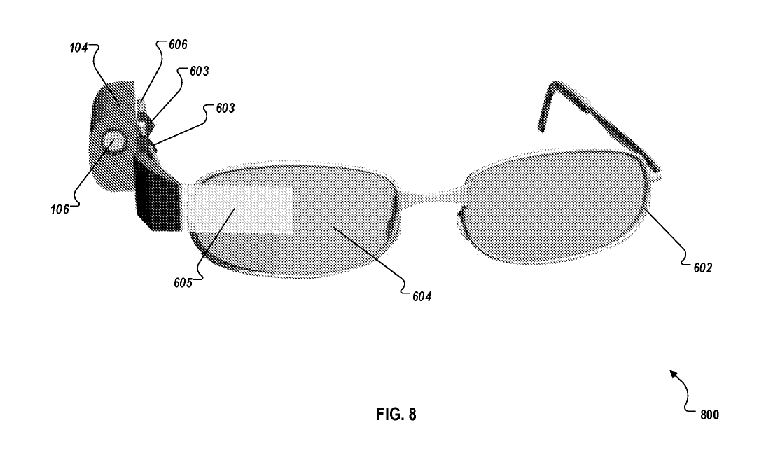

FIG. 8 illustrates another perspective view 800 of the alternative thermal imaging accessory of FIG. 6 attached to the head-mounted support according to an implementation.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example, LINUX, UNIX, WINDOWS, MAC OS, ANDROID, IOS, or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface including, but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language-independent or -dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking and parallel processing may be advantageous.

Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

What is claimed is:

1. A computer-implemented method comprising:
linking a thermal imaging accessory (TIA) to a head-mounted smart device (HMSD);
activating a thermal imaging application on the HMSD to receive data from the TIA and display it on an HMSD data display;
receiving thermal imaging data of a target from the TIA;
processing the thermal imaging data received from the TIA; and
initiating a display of the processed thermal imaging data on the HMSD data display.

2. The computer-implemented method of claim 1, comprising linking a mobile computing device (MCD) to the at least one of the TIA or the HMSD.

3. The computer-implemented method of claim 2, comprising executing an application on the HMSD that seeks out at least one of an in-range TIA or MCD to establish a data connection with the HMSD.

4. The computer-implemented method of claim 1, comprising transmitting data from the HMSD to the TIA.

5. The computer-implemented method of claim 1, wherein additional data is processed with the thermal imaging data.

6. The computer-implemented method of claim 1, comprising determining a range from the HMSD to the target.

7. The computer-implemented method of claim 1, wherein the processed thermal imaging data is displayed according to preset or dynamically-determined preferences.

8. A non-transitory, computer-readable medium storing computer-readable instructions executable by a computer and configured to:
link a thermal imaging accessory (TIA) to a head-mounted smart device (HMSD);
activate a thermal imaging application on the HMSD to receive data from the TIA and display it on an HMSD data display;
receive thermal imaging data of a target from the TIA;
process the thermal imaging data received from the TIA; and
initiate a display of the processed thermal imaging data on the HMSD data display.

9. The non-transitory, computer-readable medium of claim 8, comprising linking a mobile computing device (MCD) to the at least one of the TIA or the HMSD.

10. The non-transitory, computer-readable medium of claim 9, comprising executing an application on the HMSD that seeks out at least one of an in-range TIA or MCD to establish a data connection with the HMSD.

11. The non-transitory, computer-readable medium of claim 8, comprising transmitting data from the HMSD to the TIA.

12. The non-transitory, computer-readable medium of claim 8, wherein additional data is processed with the thermal imaging data.

13. The non-transitory, computer-readable medium of claim 8, comprising determining a range from the HMSD to the target.

14. The non-transitory, computer-readable medium of claim 8, wherein the processed thermal imaging data is displayed according to preset or dynamically-determined preferences.

15. A system, comprising:
a thermal imaging accessory (TIA); and
a head-mounted smart device (HMSD) with a data display for displaying data for an eye of a user wearing the HMSD, wherein the HMSD supports the TIA in an orientation where a field-of-view of a thermal imaging camera of the TIA is substantially in alignment with the field-of-view of an eye looking through the data display, and wherein the HMSD is configured to:
link the TIA to the HMSD;
activate a thermal imaging application on the HMSD to receive data from the TIA and display it on an HMSD data display;
receive thermal imaging data of a target from the TIA;
process the thermal imaging data received from the TIA; and
initiate a display of the processed thermal imaging data on the HMSD data display, wherein the processed thermal imaging data is displayed according to preset or dynamically-determined preferences.

16. The system of claim 15, comprising linking a mobile computing device (MCD) to the at least one of the TIA or the HMSD.

17. The system of claim 16, comprising executing an application on the HMSD that seeks out at least one of an in-range TIA or MCD to establish a data connection with the HMSD.

18. The system of claim 15, comprising transmitting data from the HMSD to the TIA.

19. The system of claim 15, wherein additional data is processed with the thermal imaging data.

20. The system of claim 15, comprising determining a range from the HMSD to the target.
